(19) United States
(12) Patent Application Publication
(10) Pub. No.: US 2024/0258572 A1
(43) Pub. Date: Aug. 1, 2024

(54) ELECTROLYTES FOR LITHIUM-RICH, LAYERED CATHODES

(71) Applicant: GM GLOBAL TECHNOLOGY OPERATIONS LLC, Detroit, MI (US)

(72) Inventors: Lei WANG, Rochester Hills, MI (US); Chuanlong WANG, Troy, MI (US)

(73) Assignee: GM GLOBAL TECHNOLOGY OPERATIONS LLC, Detroit, MI (US)

(21) Appl. No.: 18/102,836

(22) Filed: Jan. 30, 2023

(51) Int. Cl. H01M 10/0569; H01M 4/505; H01M 10/052

(52) U.S. Cl. CPC H01M 10/0569; H01M 4/505; H01M 10/052; H01M 2300/004

(57) ABSTRACT

An electrode for an electrochemical cell that cycles lithium ion includes a porous electroactive layer and an electrolyte disposed in at least a portion of pores of the porous electroactive layer. The porous electroactive layer includes an electroactive material represented by:

xLi₂MnO₃·(1-x)LiMO₂

where M is a transition metal selected from the group consisting of: nickel (Ni), manganese (Mn), cobalt (Co), aluminum (Al), iron (Fe), and combinations thereof and 0.01≤x≤0.99. The electrolyte includes a lithium salt and a first solvent that includes 2,2,2-trifluoroethyl acetate (TFEA). The electrolyte may also include a second solvent that includes fluoroethylene carbonate (FEC) and/or a third solvent that includes diethyl carbonate (DEC). A ratio of the first solvent to the second solvent to the third solvent may be greater than or equal to about 1:1:98 to less than or equal to about 98:1:1.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, positive electrodes may include lithium-rich, layered electroactive materials, such as xLi₂MnO₃·(1-x)LiMO₂ or Li_{1+y}M_{1-y}Oλ (M=Mn, Ni, Co, etc., 0<x<1, 0<y≤0.33), which are capable of providing improved capacity capability (e.g., greater than about 200 mAh/g) at high operating voltages (e.g., greater than about 3.5 V). Such materials, however, are often susceptible to voltage decay, for example, as a result of structural transformations (e.g., from layered phase to spinel phase). Accordingly, it would be desirable to develop improved battery materials that can address these challenges.

### SUMMARY

This section provides a general summary of the disclosure and is not a comprehensive disclosure of its full scope or all of its features.

The present disclosure relates to electrolyte systems for electrochemical cells that cycle lithium ions, and more particularly, to electrolyte systems for lithium-rich, layered electrodes and electrochemical cells including the same.

In various aspects, the present disclosure provides an electrode for an electrochemical cell that cycles lithium ion. The electrode may include a porous electroactive layer and an electrolyte disposed in at least a portion of pores of the porous electroactive layer. The porous electroactive layer may include an electroactive material. The electroactive material may be represented by:

xLi₂MnO₃·(1-x)LiMO₂

where M is a transition metal selected from the group consisting of: nickel (Ni), manganese (Mn), cobalt (Co), aluminum (Al), iron (Fe), and combinations thereof and 0.01≤x≤0.99. The electrolyte may include a lithium salt and 2,2,2-trifluoroethyl acetate (TFEA).

In one aspect, the 2,2,2-trifluoroethyl acetate (TFEA) may be a first solvent and the electrolyte may further include a second solvent. The second solvent may include a carbonate-based solvent, a sulfone-based solvent, a nitrile-based solvent, or any combination thereof.

In one aspect, the second solvent may be selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

In one aspect, a volumetric ratio of the first solvent to the second solvent may be greater than or equal to about 20:80 to less than or equal to about 50:50.

In one aspect, the 2,2,2-trifluoroethyl acetate (TFEA) may be a first solvent and the electrolyte may further include a second solvent and a third solvent. The second and third solvents may be carbonate-based solvents, sulfone-based solvents, nitrile-based solvents, or any combination thereof.

In one aspect, the second solvent and the third solvent may be independently selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

In one aspect, the second solvent may include diethyl carbonate (DEC).

In one aspect, the third solvent may include fluoroethylene carbonate (FEC).

In one aspect, a volumetric ratio of the first solvent to the second solvent to the third solvent may be greater than or equal to about 1:1:98 to less than or equal to about 98:1:1.

In one aspect, the electrolyte may have a lithium salt concentration greater than or equal to about 0.1 mol/L to less than or equal to about 10 mol/L. The lithium salt may be selected from the group consisting of: lithium hexafluorophosphate (LiPF₆), lithium perchlorate (LiClO₄), lithium tetrafluoroborate (LiBF₄), lithium hexafluoroarsenate (LiAsF₆), lithium bis(trifluoromethanesulfonyl)imide (LiTFSI), lithium bis(fluorosulfonyl)imide (LiN(FSO₂)₂) (LiSFI), lithium difluoro(oxalato)borate (LiDFOB), lithium bis(oxalato)borate (LiB(C₂O₄)₂) (LiBOB), lithium difluorophosphate (LiPO₂F₂), lithium tetrachloroaluminate (LiAlCl₄), lithium iodide (LiI), lithium bromide (LiBr), lithium thiocyanate (LiSCN), lithium tetraphenylborate (LiB(C₆H₅)₄), lithium difluorooxalatoborate (LiBF₂(C₂O₄)), lithium trifluoromethanesulfonate (LiCF₃SO₃), lithium bis(trifluoromethane)sulfonylimide (LiN(CF₃SO₂)₂), and combinations thereof.

In one aspect, the electrolyte may further include greater than or equal to about 0.01 wt. % to less than or equal to about 10 wt. % of an electrolyte additive.

In one aspect, the electrolyte additive may be selected from the group consisting of: lithium difluorophosphate (LiPO₂F₂), lithium difluoro(oxalato)borate (LiDFOB), lithium bis(trifluoromethanesulfonyl)imide (LiTFSI), magnesium bis(trifluoromethanesulfonyl)imide (MgTFSI), calcium bis(trifluoromethanesulfonyl)imide (CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), and combinations thereof.

In various aspects, the present disclosure provides an electrochemical cell that cycles lithium ions. The electrochemical cell may include a positive electrode that includes a positive electroactive material represented by:

xLi₂MnO₃·(1-x)LiMO₂

where M is a transition metal selected from the group consisting of: nickel (Ni), manganese (Mn), cobalt (Co), aluminum (Al), iron (Fe), and combinations thereof and 0.01≤x≤0.99. The electrochemical cell may also include a negative electrode that includes a negative electroactive material, a separating layer disposed between the positive electrode and the negative electrode, and an electrolyte at least partially infiltrating pores of at least one of the positive electrode, the negative electrode, and the separating layer. The electrolyte may include a lithium salt and a solvent, where the solvent includes 2,2,2-trifluoroethyl acetate (TFEA).

In one aspect, the solvent may be a first solvent, and the electrolyte may further include a second solvent. The second solvent may be selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

In one aspect, a volumetric ratio of the first solvent to the second solvent may be greater than or equal to about 20:80 to less than or equal to about 50:50.

In one aspect, the electrolyte may further include a third solvent that is different from the second solvent. The third solvent may be selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

In one aspect, a volumetric ratio of the first solvent to the second solvent to the third solvent may be greater than or equal to about 1:1:98 to less than or equal to about 98:1:1.

In one aspect, the electrolyte may further include greater than or equal to about 0.01 wt. % to less than or equal to about 10 wt. % of an electrolyte additive. The electrolyte additive may be selected from the group consisting of: lithium difluorophosphate (LiPO₂F₂), lithium difluoro(oxalato)borate (LiDFOB), lithium bis(trifluoromethanesulfonyl)imide (LiTFSI), magnesium bis(trifluoromethanesulfonyl)imide (MgTFSI), calcium bis(trifluoromethanesulfonyl)imide (CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), and combinations thereof.

In various aspects, the present disclosure provides an electrode for an electrochemical cell that cycles lithium ion. The electrode may include a porous electroactive layer and an electrolyte disposed in at least a portion of pores of the porous electroactive layer. The porous electroactive layer may include an electroactive material represented by:

xLi₂MnO₃·(1-x)LiMO₂

where M is a transition metal selected from the group consisting of: nickel (Ni), manganese (Mn), cobalt (Co), aluminum (Al), iron (Fe), and combinations thereof and 0.01≤x≤0.99. The electrolyte may include a lithium salt, a first solvent that includes 2,2,2-trifluoroethyl acetate (TFEA), a second solvent that includes fluoroethylene carbonate (FEC), and a third solvent that includes diethyl carbonate (DEC). A ratio of the first solvent to the second solvent to the third solvent may be greater than or equal to about 1:1:98 to less than or equal to about 98:1:1.

In one aspect, the electrolyte may further include greater than or equal to about 0.01 wt. % to less than or equal to about 10 wt. % of an electrolyte additive. The electrolyte additive may be selected from the group consisting of: lithium difluorophosphate (LiPO₂F₂), lithium difluoro(oxalato)borate (LiDFOB), lithium bis(trifluoromethanesulfonyl)imide (LiTFSI), magnesium bis(trifluoromethanesulfonyl)imide (MgTFSI), calcium bis(trifluoromethanesulfonyl)imide (CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein is for illustrative purposes only of selected embodiments and not all possible implementations, and is not intended to limit the scope of the present disclosure.

FIG. 1 is an illustration of an example electrochemical cell including an electrolyte system in accordance with various aspects of the present disclosure;

FIG. 2 is a graphical illustration demonstrating the areal discharge capacity and discharge capacity retention of the example cells including electrolyte systems in accordance with various aspects of the present disclosure;

FIG. 3 is a graphical illustration demonstrating the areal discharge capacity and discharge capacity retention of the example cells including electrolyte systems in accordance with various aspects of the present disclosure; and

FIG. 4 is a graphical illustration demonstrating the heat flow of an example cell including an electrolyte system in accordance with various aspects of the present disclosure.

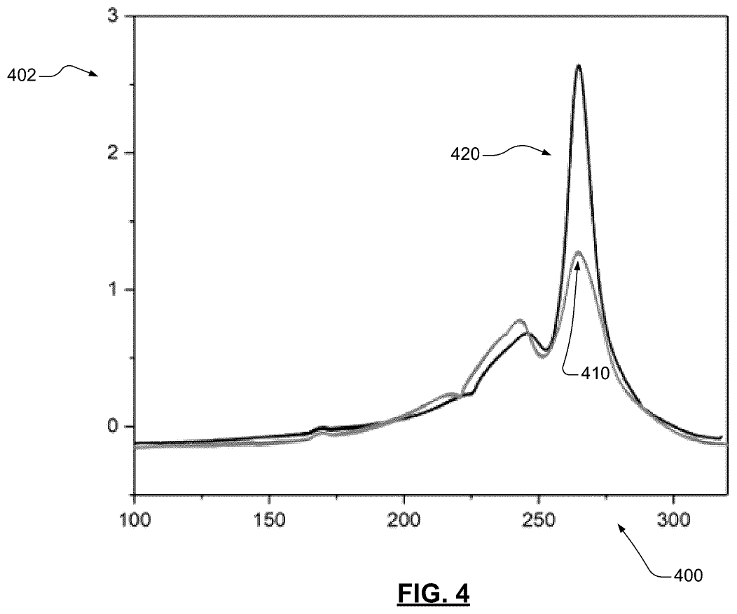

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawing.

The present disclosure relates to electrolyte systems for electrochemical cells that cycle lithium ions, and more particularly, to electrolyte systems for lithium-rich, layered electrodes and electrochemical cells including the same. In each instance, the electrochemical cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

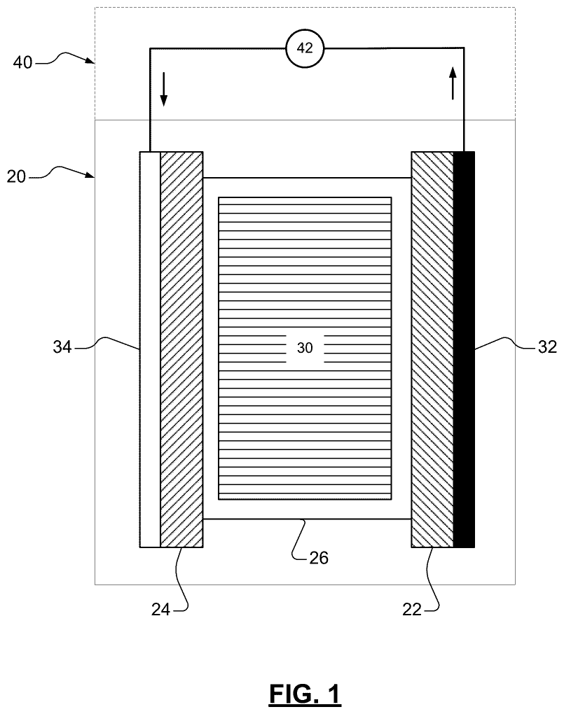

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 may include an electrolyte 30 that may, in certain aspects, also be present in the negative electrode 22 and/or the positive electrode 24, so as to form a continuous electrolyte network. In certain variations, the separator 26 may be a solid-state electrolyte or a semi-solid-state electrolyte (e.g., gel electrolyte). For example, the separator 26 may include a plurality of solid-state electrolyte particles alone or together with a liquid electrolyte, like the electrolyte 30. The positive electrode 24 and/or the negative electrode 22 may also include a plurality of solid-state electrolyte particles alone or together with a liquid electrolyte, like the electrolyte 30. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode (which can also be referred to as a negative electroactive material layer) 22. The first current collector 32 together with the negative electrode 22 may be referred to as a negative electrode assembly. Although not illustrated, the skilled artisan will appreciate that, in certain variations, negative electroactive material layers 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode (which can also be referred to as a positive electroactive material layer) 24. The second current collector 34 together with the positive electrode 24 may be referred to as a positive electrode assembly. Although not illustrated, the skilled artisan will appreciate that, in certain variations, positive electroactive material layer 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24, may be used in the battery 20. In certain aspects, the electrolyte 30 may be a non-aqueous liquid electrolyte solution that includes a lithium salt dissolved in an organic solvent. The electrolyte 30 may have a lithium salt concentration greater than or equal to about 0.1 mol/L to less than or equal to about 10 mol/L.

A non-limiting list of lithium salts that may be dissolved in the organic solvent to form the non-aqueous liquid electrolyte solution include lithium hexafluorophosphate (LiPF₆), lithium perchlorate (LiClO₄), lithium tetrafluoroborate (LiBF₄), lithium hexafluoroarsenate (LiAsF₆), lithium bis(trifluoromethanesulfonyl)imide (LiTFSI), lithium bis(fluorosulfonyl)imide (LiN(FSO₂)₂) (LiSFI), lithium difluoro(oxalato)borate (LiDFOB), lithium bis(oxalato)borate (LiB(C₂O₄)₂) (LiBOB), lithium difluorophosphate (LiPO₂F₂), lithium tetrachloroaluminate (LiAlCl₄), lithium iodide (LiI), lithium bromide (LiBr), lithium thiocyanate (LiSCN), lithium tetraphenylborate (LiB(C₆H₅)₄), lithium difluorooxalatoborate (LiBF₂(C₂O₄)), lithium trifluoromethanesulfonate (LiCF₃SO₃), lithium bis(trifluoromethane)sulfonylimide (LiN(CF₃SO₂)₂), and any combination thereof. For example, in certain variations, the lithium salt may be selected from the group consisting of: lithium hexafluorophosphate (LiPF₆), lithium perchlorate (LiClO₄), lithium tetrafluoroborate (LiBF₄), lithium hexafluoroarsenate (LiAsF₆), lithium bis(trifluoromethanesulfonyl)imide (LiTFSI), lithium bis(fluorosulfonyl)imide (LiN(FSO₂)₂) (LiSFI), lithium difluoro(oxalato)borate (LiDFOB), lithium bis(oxalato)borate (LiB(C₂O₄)₂) (LiBOB), lithium difluorophosphate (LiPO₂F₂), lithium tetrachloroaluminate (LiAlCl₄), lithium iodide (LiI), lithium bromide (LiBr), lithium thiocyanate (LiSCN), lithium tetraphenylborate (LiB(C₆H₅)₄), lithium difluorooxalatoborate (LiBF₂(C₂O₄)), lithium trifluoromethanesulfonate (LiCF₃SO₃), lithium bis(trifluoromethane)sulfonylimide (LiN(CF₃SO₂)₂), and combinations thereof. Further still, in certain variations, the lithium salt may be selected from the group consisting of: lithium hexafluorophosphate (LiPF₆), lithium perchlorate (LiClO₄), lithium tetrafluoroborate (LiBF₄), lithium hexafluoroarsenate (LiAsF₆), lithium bis(trifluoromethanesulfonyl)imide (LiTFSI), lithium bis(fluorosulfonyl)imide (LiN(FSO₂)₂) (LiSFI), lithium difluoro(oxalato)borate (LiDFOB), lithium bis(oxalato)borate (LiB(C₂O₄)₂) (LiBOB), lithium difluorophosphate (LiPO₂F₂), and combinations thereof.

The organic solvent includes 2,2,2-trifluoroethyl acetate (TFEA). In certain variations, the organic solvent may include a first organic solvent and a second organic solvent. A volume ratio of the first solvent to the second solvent may be greater than or equal to about 1:99 to less than or equal to about 99:1, and in certain aspects, optionally greater than or equal to about 20:80 to less than or equal to about 50:50. The first solvent may include 2,2,2-trifluoroethyl acetate (TFEA). The second solvent may include a carbonate-based solvent (e.g., diethyl carbonate (DEC), fluoroethylene carbonate (FEC), dimethyl carbonate (DMC), ethylmethylcarbonate (EMC), ethylene carbonate (EC), propylene carbonate (PC), and/or vinyl ethylene carbonate (VEC)), a sulfone-based solvent (e.g., tetramethylene sulfone (TMS) and/or ethyl methyl sulfone (EMS)), a nitrile-based solvent (e.g., acetonitrile (AN) and/or butyronitrile (BN)), or any combination thereof. For example, the second solvent may include diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), or any combination thereof. In certain variations, the second solvent may be selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

In other variations, the organic solvent may include a first organic solvent, a second organic solvent, and a third organic solvent. A volume ratio of the first solvent to the second solvent to the third solvent may be greater than or equal to about 1:1:98 to less than or equal to about 98:1:1, and in certain aspects, optionally greater than or equal to about 20:60:20 to less than or equal to about 50:30:20. The first solvent may include 2,2,2-trifluoroethyl acetate (TFEA). The second and third solvents may be carbonate-based solvents, sulfone-based solvent, nitrile-based solvents, or a combination thereof. For example, the second solvent may include diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), or any combination thereof, and the third solvent may include diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), or any combination thereof, where the third solvent is different form the second solvent. For example, in certain variations, the second and third solvents may be independently selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

In certain variations, the electrolyte 30 may also include an electrolyte additive. For example, the electrolyte 30 may include greater than or equal to about 0.01 weight percent (wt. %) to less than or equal to about 10 wt. %, and in certain aspects, optionally greater than or equal to about 0.1 wt. % to less than or equal to about 2 wt. %, of the electrolyte additive. The electrolyte additive may include, for example, lithium difluorophosphate (LiPO₂F₂), lithium difluoro(oxalato)borate (LiDFOB), lithium or magnesium or calcium bis(trifluoromethanesulfonyl)imide (LiTFSI, MgTFSI, CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), or any combination thereof. In certain variations, the electrolyte additive may be selected from the group consisting of: lithium difluorophosphate (LiPO₂F₂), lithium difluoro(oxalato)borate (LiDFOB), lithium bis(trifluoromethanesulfonyl)imide (LiTFSI), magnesium bis(trifluoromethanesulfonyl)imide (MgTFSI), calcium bis(trifluoromethanesulfonyl)imide (CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material. The ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: NOMEX™ meta-aramid (e.g., an aromatic polyamide formed from a condensation reaction from monomers m-phenylendiamine and isophthaloyl chloride), ARAMID aromatic polyamide, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

The negative electrode (also referred to as the negative electroactive material layer) 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. In each instance, the negative electrode 22 (including the one or more layers) may have a thickness greater than 0 nanometer (nm) to less than or equal to about 500 μm, optionally greater than or equal to about 1 μm to less than or equal to about 500 μm, and in certain aspects, optionally greater than or equal to about 10 μm to less than or equal to about 200 μm.

In certain variations, the negative electrode 22 may include a silicon-based negative electroactive material, including, for example lithium-silicon, silicon containing binary and/or ternary alloys, and/or tin-containing alloys (such as, Si, Li—Si, SiOₓ (where 0≤x≤2), lithium doped SiOₓ (where 0≤x≤2) (e.g., LiₓSiO_{y} (where 2≤x≤6 and 4≤y≤7)), Si—Sn, SiSnFe, SiSnAl, SiFeCo, SnO₂, and/or the like). In other variations, the negative electrode 22 may include one or more other volume-expanding negative electroactive materials (e.g., aluminum, germanium, tin). In still other variations, the negative electrode 22 may include a lithium-containing negative electroactive material, such as a lithium alloy and/or a lithium metal. For example, in certain variations, the negative electrode 22 may be defined by a lithium metal foil. In still other variations, the negative electrode 22 may include, for example only, carbonaceous negative electroactive materials (such as, graphite, hard carbon, soft carbon, and the like) and/or metallic active materials (such as tin, aluminum, magnesium, germanium, and alloys thereof, and the like).

In further variations, the negative electrode 22 may be a composite electrode including a combination of negative electroactive materials. For example, the negative electrode 22 may include a first negative electroactive material and a second negative electroactive material. A mass ratio of the first negative electroactive material to the second negative electroactive material may be greater than or equal to about 5:95 to less than or equal to about 95:5. In certain variations, the first negative electroactive material may be a volume-expanding material including, for example, silicon, aluminum, germanium, and/or tin; and the second negative electroactive material may include a carbonaceous material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite.

In each variation, the negative electroactive material may be optionally intermingled with an electronically conductive material (i.e. conductive additive) that provides an electron conductive path and/or a polymeric binder material that improves the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The positive electrode (also referred to as the positive electroactive material layer) 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electrode 24 may be a lithium-rich layered cathode including a positive electroactive material represented by:

xLi₂MnO₃·(1-x)LiMO₂

where M are transitions metals (for example, independently selected from the group consisting of: nickel (Ni), manganese (Mn), cobalt (Co), aluminum (Al), iron (Fe), and combinations thereof) and 0.01≤x≤0.99. In other variations, the positive electrode 24 may be a layered oxide represented by LiMeO₂, where Me is a transition metal, such as cobalt (Co), nickel (Ni), manganese (Mn), iron (Fe), aluminum (Al), vanadium (V), or combinations thereof. For example, the positive electrode 24 may include Li_{1.2}Ni_{0.12}Co_{0.12}Mn_{0.56}O₂ and/or Li_{1.2}Ni_{0.24}Mn_{0.56}O₂.

In other variations, the positive electrode 24 may be a composite electrode including two or more positive electroactive material. For example, the positive electrode 24 may include a first positive electroactive material and a second positive electroactive material. In certain variations, a ratio of the first positive electroactive material to the second positive electroactive material may be greater than or equal to about 1:9 to less than or equal to about 9:1. The first positive electroactive material may include the lithium-rich, layered positive electroactive material. The second positive electrode material may include, for example, an olivine-type oxide represented by LiMePO₄, where Me is a transition metal, such as cobalt (Co), nickel (Ni), manganese (Mn), iron (Fe), aluminum (Al), vanadium (V), or combinations thereof; a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof; a spinel-type oxide represented by LiMe₂O₄, where Me is a transition metal, such as cobalt (Co), nickel (Ni), manganese (Mn), iron (Fe), aluminum (Al), vanadium (V), or combinations thereof; a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof; and/or combinations thereof.

In each variation, the positive electroactive material may also be optionally intermingled with an electronically conductive material (i.e. conductive additive) that provides an electron conductive path and/or a polymeric binder material that improves the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the positive electrode 24 may be the same as or different from the conductive additive as included in the negative electrode 22.

In each variation, the battery 20 may have a negative electrode capacity for lithium to positive electrode capacity for lithium (N/P) ratio greater than or equal to about 1 to less than or equal to about 3.

Certain features of the current technology are further illustrated in the following non-limiting examples.

### Example 1

Example batteries and battery cells may be prepared in accordance with various aspects of the present disclosure.

For example, a first example cell 210 may include a lithium-rich, layered cathode and a composite anode including, for example, silicon oxide and graphite. The first example cell 210 may also include a first example electrolyte including, for example, lithium hexafluorophosphate (LiPF₆) as the lithium salt and a solvent system that includes 2,2,2-trifluoroethyl acetate (TFEA) as a first solvent, diethyl carbonate (DEC) as a second solvent, and fluoroethylene carbonate (FEC) as a third solvent, where a volumetric ratio of the first solvent to the second solvent to the third solvent may be about 40:40:20.

A second example cell 220 may similarly include a lithium-rich, layered cathode and a composite anode including, for example, silicon oxide and graphite. The second example cell 220 may include, however, a second example electrolyte including, for example, lithium hexafluorophosphate (LiPF₆) as the lithium salt and a solvent system that includes 2,2,2-trifluoroethyl acetate (TFEA) as a first solvent, diethyl carbonate (DEC) as a second solvent, and fluoroethylene carbonate (FEC) as a third solvent, where volumetric ratio of the first solvent to the second solvent to the third solvent may be about 20:60:20.

A comparative or baseline cell 230 may include similarly include a lithium-rich, layered cathode and a composite anode including, for example, silicon oxide and graphite. The comparative cell 230 may include, however, a third example electrolyte including, for example, lithium hexafluorophosphate (LiPF₆) as the lithium salt and a solvent system that includes diethyl carbonate (DEC) as a first solvent and fluoroethylene carbonate (FEC) as a second solvent, where a volumetric ratio of the first solvent to the second solvent may be about 80:20.

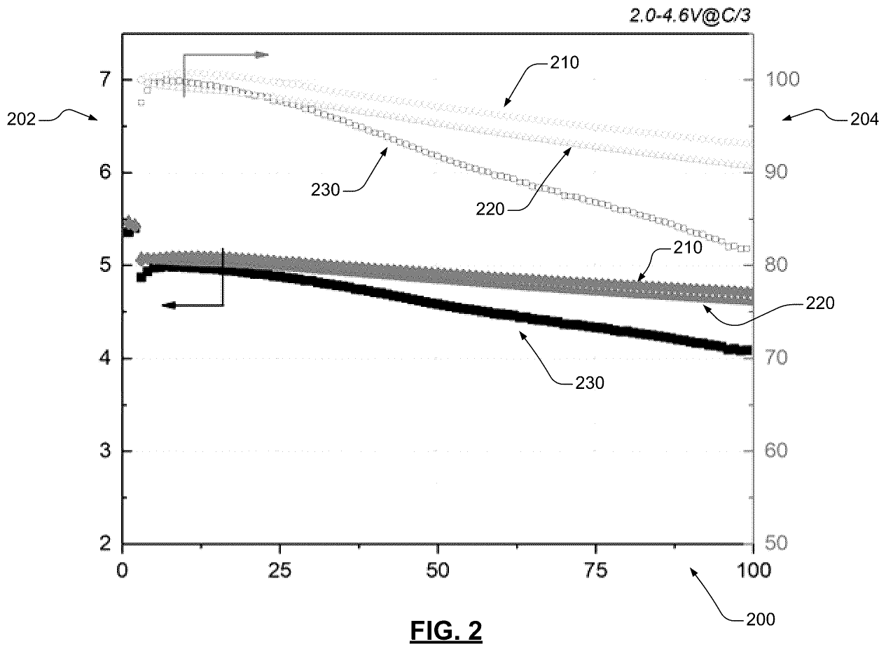

FIG. 2 is a graphical illustration demonstrating the areal discharge capacity and discharge capacity retention of the example cells 210, 220 as compared to the comparative cell 230, where the x-axis 200 represents cycle number, the y₁-axis 202 represents areal discharge capacity (mAh·cm⁻²), and the y₂-axis 204 represents discharge capacity retention (%). As illustrated, the comparative cell 230 may have a capacity retention of about 82% after about 100 cycles, while the example cell 220 may have a capacity retention of about 90% after about 100 cycles, and the example cell 230 may have a capacity retention of about 93% after about 100 cycles.

### Example 2

Example batteries and battery cells may be prepared in accordance with various aspects of the present disclosure.

For example, a first example cell 310 may include a lithium-rich, layered cathode and a composite anode including, for example, silicon oxide and graphite. The first example cell 310 may also include a first example electrolyte including, for example, lithium hexafluorophosphate (LiPF₆) as the lithium salt and a solvent system that includes 2,2,2-trifluoroethyl acetate (TFEA) as a first solvent, diethyl carbonate (DEC) as a second solvent, and fluoroethylene carbonate (FEC) as a third solvent, where a volumetric ratio of the first solvent to the second solvent to the third solvent may be about 40:40:20.

A second example cell 320 may similarly include a lithium-rich, layered cathode and a composite anode including, for example, silicon oxide and graphite. The second example cell 320 may include, however, a second example electrolyte including, for example, lithium hexafluorophosphate (LiPF₆) as the lithium salt, an electrolyte additive that includes lithium difluorophosphate (LiPO₂F₂), and a solvent system that includes 2,2,2-trifluoroethyl acetate (TFEA) as a first solvent, diethyl carbonate (DEC) as a second solvent, and fluoroethylene carbonate (FEC) as a third solvent, where volumetric ratio of the first solvent to the second solvent to the third solvent may be about 40:40:20. The second example electrolyte may include about 1 wt. % of the electrolyte additive.

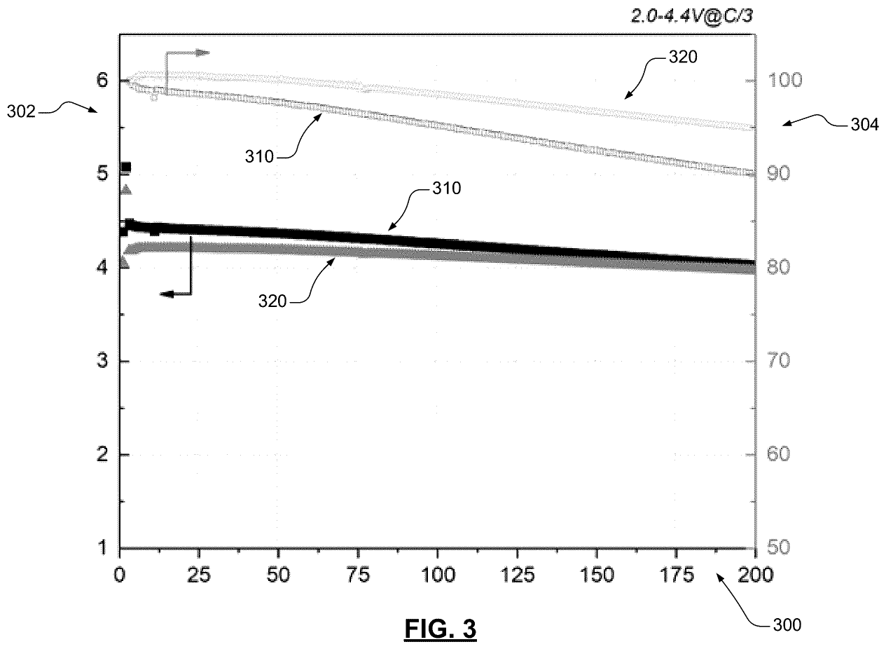

FIG. 3 is a graphical illustration demonstrating the areal discharge capacity and discharge capacity retention of the example cells 310, 320, where the x-axis 300 represents cycle number, the y₁-axis 302 represents areal discharge capacity (mAh·cm⁻²), and the y₂-axis 304 represents discharge capacity retention (%). As illustrated, the first example cell 310 may have a capacity retention of about 90% after about 200 cycles, and the second example cell 320 may have a capacity retention of about 95% after about 200 cycles.

### Example 3

Example batteries and battery cells may be prepared in accordance with various aspects of the present disclosure.

For example, an example cell 410 may include a lithium-rich, layered cathode and a composite anode including, for example, silicon oxide and graphite. The example cell 410 may also include a first example electrolyte including, for example, lithium hexafluorophosphate (LiPF₆) as the lithium salt and a solvent system that includes 2,2,2-trifluoroethyl acetate (TFEA) as a first solvent, diethyl carbonate (DEC) as a second solvent, and fluoroethylene carbonate (FEC) as a third solvent, where a volumetric ratio of the first solvent to the second solvent to the third solvent may be about 20:60:20.

A comparative or baseline cell 420 may include similarly include a lithium-rich, layered cathode and a composite anode including, for example, silicon oxide and graphite. The comparative cell 420 may include, however, a second example electrolyte including, for example, lithium hexafluorophosphate (LiPF₆) as the lithium salt and a solvent system that includes diethyl carbonate (DEC) as a first solvent and fluoroethylene carbonate (FEC) as a second solvent, where a volumetric ratio of the first solvent to the second solvent may be about 80:20.

FIG. 3 is a graphical illustration demonstrating heat flow of the example cell 410 as compared to the comparative cell 420, where the x-axis 400 represents temperature (° C.), and the y-axis 402 represents heat flow (W/g). As illustrated, the example cell 210 releases less total heat when reacting with the cell materials, like the positive electroactive materials, as compared to the comparative cell 420, which omits 2,2,2-trifluoroethyl acetate (TFEA).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for an electrochemical cell that cycles lithium ion, the electrode comprising:
a porous electroactive layer comprising an electroactive material represented by:
$$x {Li}_{2} {MnO}_{3} \cdot ( 1 - x ) {LiMO}_{2}$$
where M is a transition metal selected from the group consisting of: nickel (Ni), manganese (Mn), cobalt (Co), aluminum (Al), iron (Fe), and combinations thereof and 0.01≤x≤0.99; and
an electrolyte comprising a lithium salt and 2,2,2-trifluoroethyl acetate (TFEA) disposed in at least a portion of pores of the porous electroactive layer.

2. The electrode of claim 1, wherein the 2,2,2-trifluoroethyl acetate (TFEA) is a first solvent and the electrolyte further comprises a second solvent, wherein the second solvent comprises a carbonate-based solvent, a sulfone-based solvent, a nitrile-based solvent, or any combination thereof.

3. The electrode of claim 2, wherein the second solvent is selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

4. The electrode of claim 2, wherein a volumetric ratio of the first solvent to the second solvent is greater than or equal to about 20:80 to less than or equal to about 50:50.

5. The electrode of claim 1, wherein the 2,2,2-trifluoroethyl acetate (TFEA) is a first solvent and the electrolyte further comprises a second solvent and a third solvent, wherein the second and third solvents are carbonate-based solvents, sulfone-based solvents, nitrile-based solvents, or any combination thereof.

6. The electrode of claim 5, wherein the second solvent and the third solvent are independently selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

7. The electrode of claim 6, wherein the second solvent comprises diethyl carbonate (DEC).

8. The electrode of claim 7, wherein the third solvent comprises fluoroethylene carbonate (FEC).

9. The electrode of claim 5, wherein a volumetric ratio of the first solvent to the second solvent to the third solvent is greater than or equal to about 1:1:98 to less than or equal to about 98:1:1.

10. The electrode of claim 1, wherein the electrolyte has a lithium salt concentration greater than or equal to about 0.1 mol/L to less than or equal to about 10 mol/L, and the lithium salt is selected from the group consisting of: lithium hexafluorophosphate (LiPF₆), lithium perchlorate (LiClO₄), lithium tetrafluoroborate (LiBF₄), lithium hexafluoroarsenate (LiAsF₆), lithium bis(trifluoromethanesulfonyl)imide (LiTFSI), lithium bis(fluorosulfonyl)imide (LiN(FSO₂)₂) (LiSFI), lithium difluoro(oxalato)borate (LiDFOB), lithium bis(oxalato)borate (LiB(C₂O₄)₂) (LiBOB), lithium difluorophosphate (LiPO₂F₂), lithium tetrachloroaluminate (LiAlCl₄), lithium iodide (LiI), lithium bromide (LiBr), lithium thiocyanate (LiSCN), lithium tetraphenylborate (LiB(C₆H₅)₄), lithium difluorooxalatoborate (LiBF₂(C₂O₄)), lithium trifluoromethanesulfonate (LiCF₃SO₃), lithium bis(trifluoromethane)sulfonylimide (LiN(CF₃SO₂)₂), and combinations thereof.

11. The electrode of claim 1, wherein the electrolyte further comprises greater than or equal to about 0.01 wt. % to less than or equal to about 10 wt. % of an electrolyte additive.

12. The electrode of claim 11, wherein the electrolyte additive is selected from the group consisting of: lithium difluorophosphate (LiPO₂F₂), lithium difluoro(oxalato)borate (LiDFOB), lithium bis(trifluoromethanesulfonyl)imide (LiTFSI), magnesium bis(trifluoromethanesulfonyl)imide (MgTFSI), calcium bis(trifluoromethanesulfonyl)imide (CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), and combinations thereof.

13. An electrochemical cell that cycles lithium ions, the electrochemical cell comprising:
a positive electrode comprising a positive electroactive material represented by:
$$x {Li}_{2} {MnO}_{3} \cdot ( 1 - x ) {LiMO}_{2}$$
where M is a transition metal selected from the group consisting of: nickel (Ni), manganese (Mn), cobalt (Co), aluminum (Al), iron (Fe), and combinations thereof and 0.01≤x≤0.99;
a negative electrode comprising a negative electroactive material;
a separating layer disposed between the positive electrode and the negative electrode; and
an electrolyte at least partially infiltrating pores of at least one of the positive electrode, the negative electrode, and the separating layer, the electrolyte comprising a lithium salt and a solvent comprising 2,2,2-trifluoroethyl acetate (TFEA).

14. The electrochemical cell of claim 13, wherein the solvent is a first solvent, and the electrolyte further comprises a second solvent selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

15. The electrochemical cell of claim 14, wherein a volumetric ratio of the first solvent to the second solvent is greater than or equal to about 20:80 to less than or equal to about 50:50.

16. The electrochemical cell of claim 14, wherein the electrolyte further comprises a third solvent different from the second solvent and selected from the group consisting of: diethyl carbonate (DEC), fluoroethylene carbonate (FEC), dimethyl carbonate (DMC), ethylmethylcarbonate (EMC), ethylene carbonate (EC), propylene carbonate (PC), vinyl ethylene carbonate (VEC), tetramethylene sulfone (TMS), ethyl methyl sulfone (EMS), acetonitrile (AN), butyronitrile (BN), and combinations thereof.

17. The electrochemical cell of claim 16, wherein a volumetric ratio of the first solvent to the second solvent to the third solvent is greater than or equal to about 1:1:98 to less than or equal to about 98:1:1.

18. The electrochemical cell of claim 13, wherein the electrolyte further comprises greater than or equal to about 0.01 wt. % to less than or equal to about 10 wt. % of an electrolyte additive selected from the group consisting of: lithium difluorophosphate (LiPO₂F₂), lithium difluoro(oxalato)borate (LiDFOB), lithium bis(trifluoromethanesulfonyl)imide (LiTFSI), magnesium bis(trifluoromethanesulfonyl)imide (MgTFSI), calcium bis(trifluoromethanesulfonyl)imide (CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), and combinations thereof.

19. An electrode for an electrochemical cell that cycles lithium ion, the electrode comprising:
a porous electroactive layer comprising an electroactive material represented by:
$$x {Li}_{2} {MnO}_{3} \cdot ( 1 - x ) {LiMO}_{2}$$
where M is a transition metal selected from the group consisting of: nickel (Ni), manganese (Mn), cobalt (Co), aluminum (Al), iron (Fe), and combinations thereof and 0.01≤x≤0.99; and
an electrolyte disposed in at least a portion of pores of the porous electroactive layer comprising:
a lithium salt;
a first solvent comprising 2,2,2-trifluoroethyl acetate (TFEA);
a second solvent comprising fluoroethylene carbonate (FEC); and
a third solvent comprising diethyl carbonate (DEC), wherein a ratio of the first solvent to the second solvent to the third solvent is greater than or equal to about 1:1:98 to less than or equal to about 98:1:1.

20. The electrode of claim 19, wherein the electrolyte further comprises greater than or equal to about 0.01 wt. % to less than or equal to about 10 wt. % of an electrolyte additive selected from the group consisting of: lithium difluorophosphate (LiPO₂F₂), lithium difluoro(oxalato)borate (LiDFOB), lithium bis(trifluoromethanesulfonyl)imide (LiTFSI), magnesium bis(trifluoromethanesulfonyl)imide (MgTFSI), calcium bis(trifluoromethanesulfonyl)imide (CaTFSI), lithium bis(oxalato)borate (LiBOB), lithium 4,5-dicyano-2-(trifluoromethyl)imidazolide (LiTDi), tris(trimethylsilyl) phosphite (TTMSPi), tris(trimethlysilyl) phosphate (TTMSP), triethyl phosphate (TEP), tris(2,2,2-trifluoroethyl) phosphite (TTFP), tris(1,1,1,3,3,3-hexafluoro-2-propyl) phosphite (THFPP), trimethyl borate (TMB), tris(trimethylsilyl)borate (TMSB), tris(pentafluorophenyl)borane (TFPFB), and combinations thereof.
